(19) United States
(12) Patent Application Publication
(10) Pub. No.: US 2014/0204565 A1
(43) Pub. Date: Jul. 24, 2014

(54) ILLUMINATION ADAPTOR

(71) Applicant: Jan Brian Zwierstra, San Pedro, CA (US)

(72) Inventor: Jan Brian Zwierstra, San Pedro, CA (US)

(21) Appl. No.: 14/157,368

(22) Filed: Jan. 16, 2014

Related U.S. Application Data
(60) Provisional application No. 61/754,190, filed on Jan. 18, 2013.
(60) Provisional application No. 61/801,998, filed on Mar. 15, 2013.

(51) Int. Cl. F21V 33/00; F21V 19/02; F21V 5/04

(52) U.S. Cl. CPC F21V 33/0004; F21V 5/04; F21V 19/02
USPC 362/101; 362/257; 362/311.01; 362/285; 29/428; 29/525.01

(57) ABSTRACT

A cap for a water bottle has an integral light director lens for guiding light into the bottle. A portable light is temporally retained on the top, outside of the cap. In that position light from the light is directed by the structure of the cap into the bottle. To retain a light with straps, such as a headlamp, the straps can be placed under fingers of the sides of the cap. This can allow the strap to be a handle for the resulting lamp. Alternatively, elastomeric straps, bands or flaps may directly secure the body of a lamp to the upper surface of the cap establishing both a mechanical and optical interface. The use of both headlamps and flashlights are taught.

### RELATED APPLICATIONS

This application claims priority from U.S. provisional application No. 61754190, filed on Jan. 18, 2013, and US provisional application No. 61801998, filed on Mar. 15, 2013. The entire disclosure of both applications is incorporated herein by reference.

### FIELD

This disclosure pertains to devices for directing illumination, more particularly it relates to portable light dispersing and defusing.

### BACKGROUND

When hiking or camping, there are serious trade-offs between having tools for comfort and safety, and reducing the number, volume, and weight of the total items carried. There is a continuing need for devices and methods that provide for multipurpose devices and devices that adapt and combine with other equipment to serve additional needs. One area includes lighting needs, which vary during phases of a camping trip.

### SUMMARY

A cap for a translucent water bottle can have a downward facing light director. Light entering at the top of the cap can be transmitted into the interior cavity of the water bottle in a manner to be directed to the interior sidewalls. With a translucent plastic bottle, the sidewalls can act as a diffuser creating a 360-degree soft ambient illumination. The source of the focused light can be a headlamp captured on the cap top. The described embodiments can retain and disconnect a lamp from a cap readily and non-destructively without requiring the use of tools.

### BRIEF DESCRIPTION OF THE DRAWINGS

FIG. 1 is a perspective view of a first example cap;

FIG. 2 is a lower view of the perspective of the cap in FIG. 1;

FIG. 3 is an upper perspective view of the cap in FIG. 1;

FIG. 4 is a cross section of the first cap example along line 4-4;

FIG. 5 is a top view of the cap in FIG. 1;

FIG. 6 is a perspective view of the first example cap with headlamp;

FIG. 7 is a side view of the first example cap with a bottle, and headlamp facedown;

FIG. 8 is a cut-away view of FIG. 7 showing light paths;

FIGS. 9A-9F show an embodiment of a cap with opposing V-shaped elastomeric tabs; 9A is a top view; 9B is a perspective view; 9C is a side view; 9D is a front view; 9E is a perspective view of the bottle, cap, and headlamp; 9F is a detailed perspective view of the bottle, cap, and headlamp;

FIGS. 10A-10F show additional views of the first example of the cap of FIGS. 1-8; 10A is a top view; 10B is a perspective view; 10C is a side view; 10D is a front view; 10E is a perspective view of the bottle, cap, and headlamp; 10F is a detailed perspective view of the bottle, cap, and headlamp;

FIGS. 11A-11E show an embodiment of a cap with a protrusion extending from the bottom surface of the cup into the bottle; 11A is a top view; 11B is a perspective view; 11C is a side view; 11D is a front view; 11E is a perspective view of the bottle, cap, and headlamp;

FIG. 12A-12E show an embodiment of a cap with two elastomeric flaps in a plane parallel to the top surface of the cap; the flaps have opposing semicircular cutouts creating a centrally located opening to hold flashlight; 12A shows a top view of a cap on a bottle in a flaps-closed position; 12B shows the cap in a flaps-closed position in perspective; 12C shows a side view of the cap; 12D shows a perspective view of the upper portion of the bottle and cap, with the flaps slightly opened; 12E shows a perspective view at a smaller scale, including a retained flashlight.

FIGS. 13A-13F show an embodiment of a cap with a resilient rubber band-like strap across the top of the cap; 13A is a top view; 13B is a perspective view; 13C is a side view; 13D is a front view; 13E is a perspective view of the bottle, cap, and headlamp; 13F is a detailed perspective view of the bottle, cap, and headlamp;

FIGS. 14A-14E show an embodiment of a cap with a semi-rigid clip; 14A is a top view; 14B is a perspective view; 14C is a side view; 14D is a front view; 14E is a detailed perspective view of the bottle, cap, and headlamp;

FIGS. 15A-15F show an embodiment of a cap with a domed lid; 15A is a top view; 15B is a perspective view; 15C is a side view; 15D is a front view; 15E is a perspective view of the bottle, cap, and headlamp; 15F is a detailed perspective view of the bottle, cap, and headlamp;

FIGS. 16A-16E show an alternate version of the domed lid embodiment of the cap in FIGS. 15A-15F with a hinge mechanism; 16A is a top view; 16B is a perspective view; 16C is a side view; 16D is a front view; 16E is a detailed perspective view of the bottle, cap, and headlamp;

FIGS. 17A-17E show a variation of the embodiment of the cap in FIGS. 13A-13F with a wider, circular strap; 17A is a top view; 17B is a perspective view; 17C is a side view; 17D is a front view; 17E is a detailed perspective view of the bottle, cap, and headlamp;

FIGS. 18A-18E show an embodiment of a cap with a partial bail short of being a semi-circle; 18A is a top view; 18B is a perspective view; 18C is a side view; 18D is a front view; 18E is a detailed perspective view of the bottle, cap, and headlamp;

FIGS. 19A-19F show a version of the embodiment of the cap in FIGS. 17A-17E with a slot in the strap; 19A is a top view; 19B is a perspective view; 19C is a side view; 19D is a front view; 19E is a perspective view of the bottle, cap, and headlamp; 19F is a detailed perspective view of the bottle, cap, and a flashlight;

FIGS. 20A-20E show an embodiment of the cap with four short, wide elastomeric fingers; 20A is a top view; 20B is a perspective view; 20C is a side view; 20E a perspective view of the bottle, cap, and headlamp; 20D is a detailed perspective view of the bottle, cap, and headlamp;

FIGS. 21A-21E show an embodiment of a cap with a rubber band; 21A is a top view; 21B is a perspective view; 21C is a side view; 21D front view; 21E is a detailed perspective view of the bottle, cap, and headlamp;

FIGS. 22A-22E show an embodiment of a cap with a folding bail-type handle; 22A is a top view; 22B is a perspective view; 22C is a side view; 22D front view; 22E is a detailed perspective view of the bottle, cap, and headlamp;

FIG. 23A-23D show an embodiment of a cap with a single elastomeric hold-down tab; 23A top view; 23B is a perspective view; 23C is a side view; 23D is a detailed perspective view of the bottle, cap, and headlamp.

### DETAILED DESCRIPTION

### Overview of Problem

The most useful light in a tent or campsite can be one with a diffused 360-degree illumination pattern. By the nature of this feature, a relatively large volume and surface can be required. This type of light is not particularly useful while on the move. For that case, a headlamp might be desired. This disclosure describes embodiments of a specialized cap for a water bottle that effectively connects a translucent water bottle to a headlamp, both mechanically and optically. The light director integrated in the cap can be a lens, fiber optics, light pipe, or just an extended protrusion. This can create a diffused ambient light source with a very small addition in weight and volume to items that might be carried in any case for their own standard use. The only added weight would be the difference between a standard water bottle cap and a diffusing cap.

### First Example Embodiment

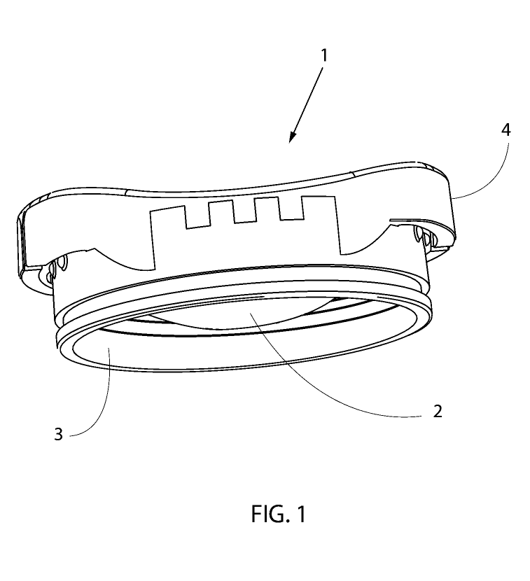

FIG. 1 shows a water bottle cap 1 with an internal lens 2. The lens is bowl-shaped with a concave upper surface and a parallel convex lower surface. FIG. 1 shows the thread 3 and the lower side of the lens 2.

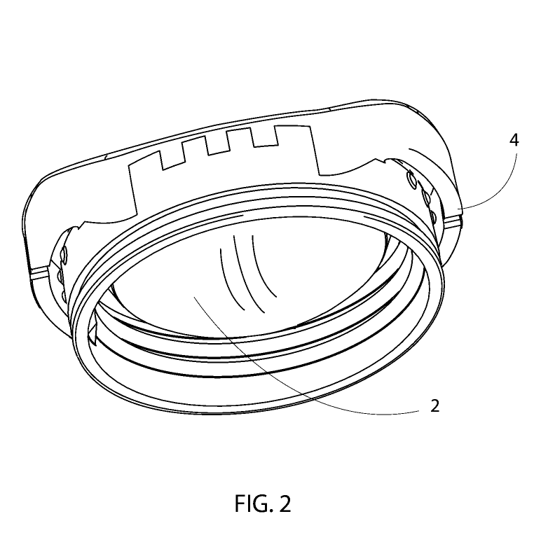

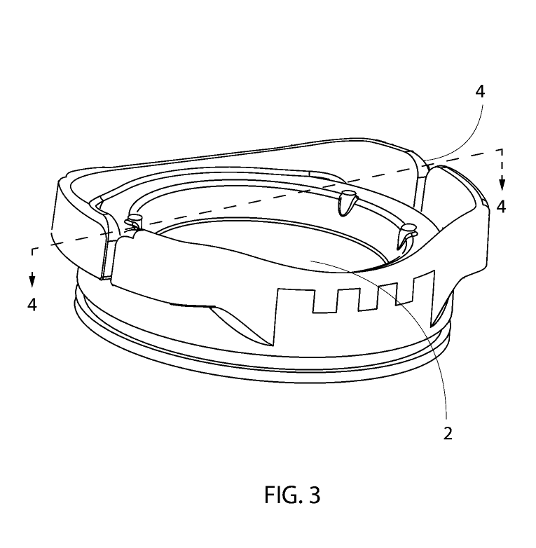

FIG. 2 is a lower perspective view of this cap. In this view fingers 4 are seen extending on the left and right sides. They can retain a strap not shown in this figure. The concave top surface of the lens can be seen in FIG. 3 as well as a view of the fingers.

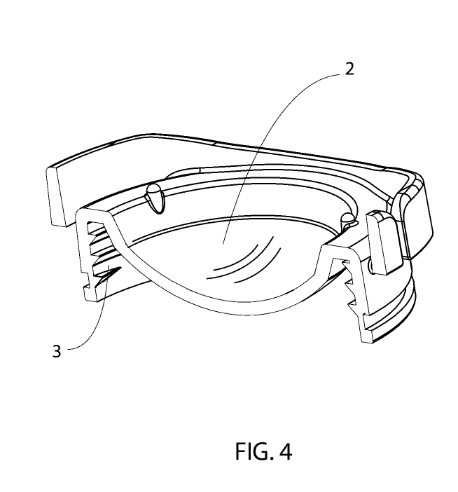

The bowl-shape of the lens 2 is clearly seen in the cross section perspective view of FIG. 4. The concave upper surface provides a location for a light source to rest and to direct the light into the bottle. A standard Nalgene bottle may be used.

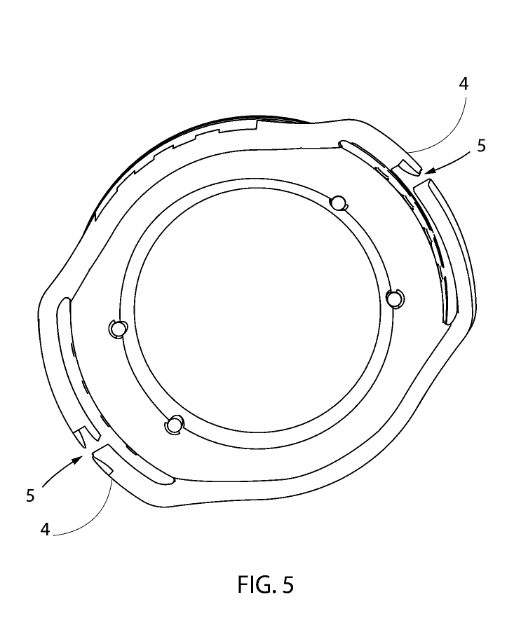

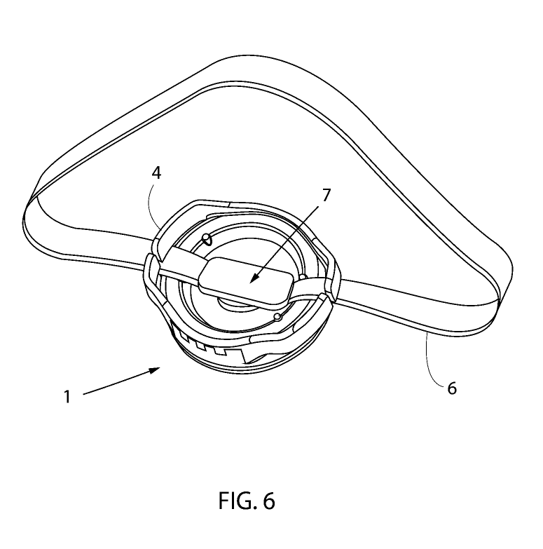

FIG. 5 is a top view showing the four fingers 4 and the gap 5 they create for retaining a strap 6, while FIG. 6 shows a headlamp 7 secured to the cap 1 via its strap 6 being placed under, and entrapped by, the fingers 4. Note that the fingers that retain the strap have their respective gaps offset from the center in an opposite, mirror-image fashion. This can help retain the strap.

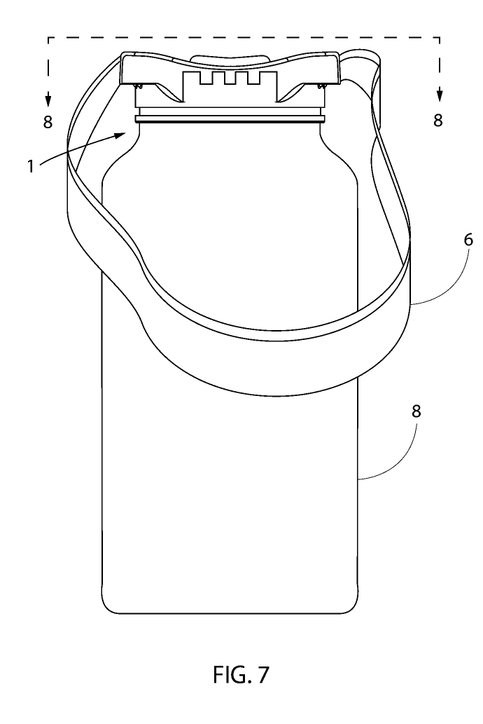

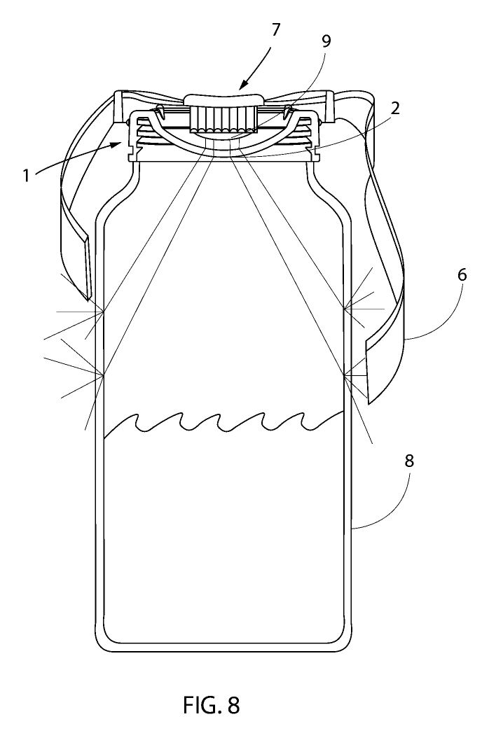

FIG. 7 shows a side view of an assembled bottle 8, a cap 1 and headlamp 7 with strap 6. This same view in a cross section in FIG. 8 shows the light path 9. Light emits from the headlamp, is dispersed by the lens to be directed to the sidewalls of the bottle. The translucent properties of the bottle's sidewalls can then diffuse the light in all directions providing a 360-degree illumination. Alternatively, the light can be focused into the water or the sidewalls can be transparent.

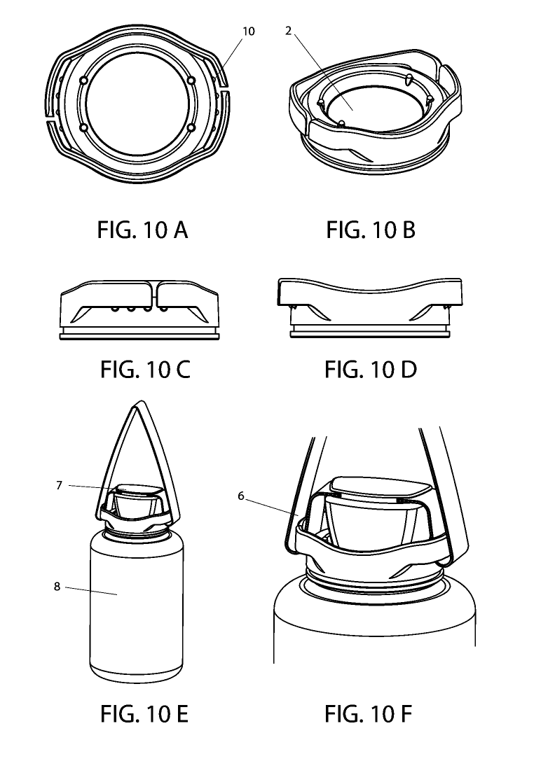

FIGS. 10A -10F also portray the embodiment seen in FIGS. 1-8. Seen in some views are friction bumps 10 in the strap-holding finger regions that prevent the headlamp strap from sliding.

### Additional Embodiments

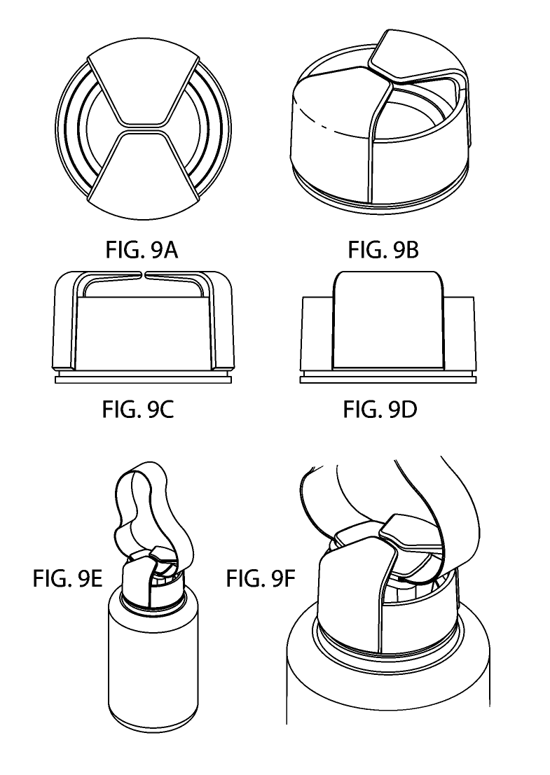

In FIGS. 9A-9F a cap is seen that has opposing V-shaped elastomeric hooks or tabs extending over the center of the cap. They can collectively hold the lamp to the upper portions of the caps. Flexing of the hooks can also help accommodate variations in the size of headlamp supported. These structures on the upper portion of the outside of cap are adapted to grip a headlamp.

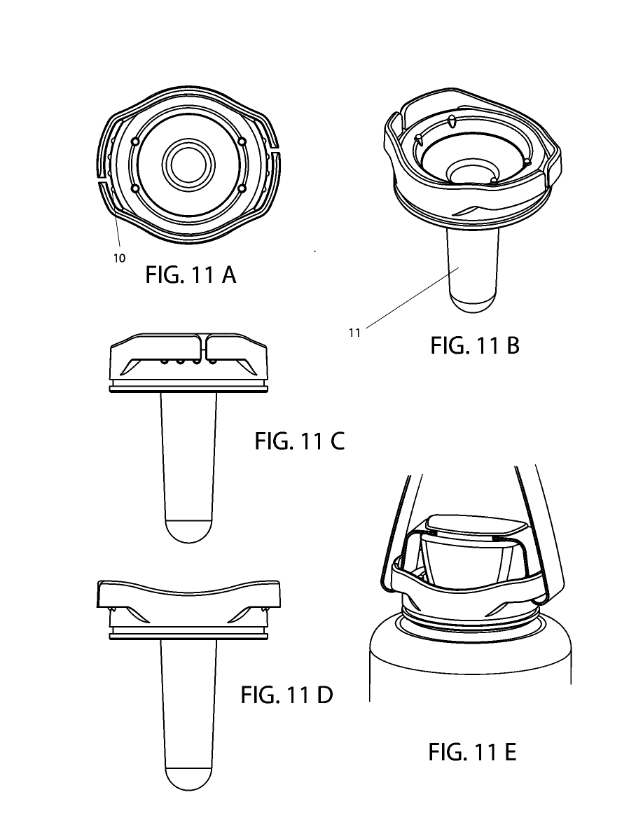

FIGS. 11A-11E show an embodiment with the cap similar to that of FIGS. 1-8, but with a descending, cylindrical lower 11 portion in place of the large convex lens. The lower portion is a deep core meant to spread the light through the volume of the bottle.

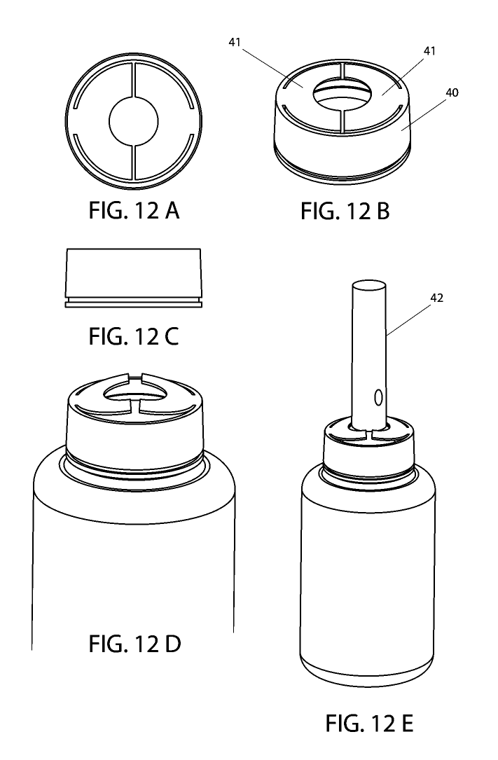

A version that supports a small flashlight on the upper surface of a cap, rather than a headlamp, is seen in FIGS. 12A-12E. This cap 40 has an opposing set of symmetric flaps 41 on a plane parallel to the plane of the cap's upper surface. They have semicircular cut-outs that form a circular opening that can capture the head of a small flashlight 42. The flaps are connected to the cap proper in a way that causes them to be spring-loaded towards closure.

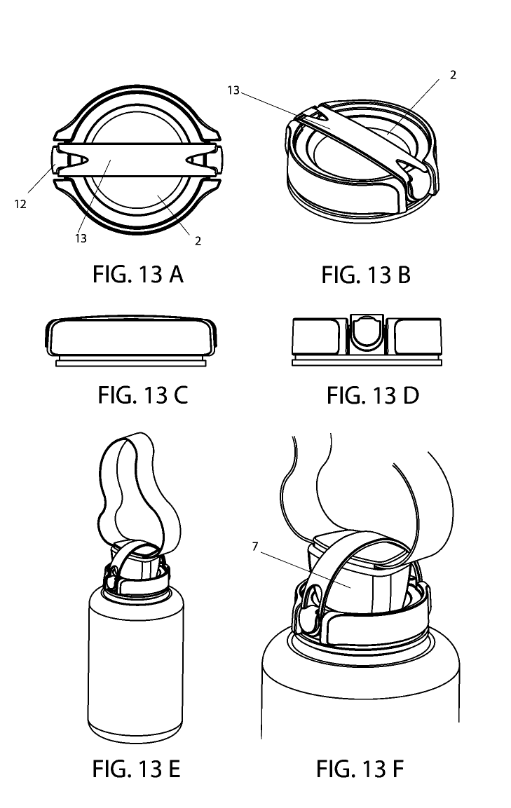

FIGS. 13A-13F show an embodiment with a resilient rubber band-like strap 13 across the top of a cap. The cap has tabs 12 on opposite edges that the ends of the straps fit over. As seen in FIGS. 13E and 13F the strap can capture a headlamp 7 and secure it to the lens 2.

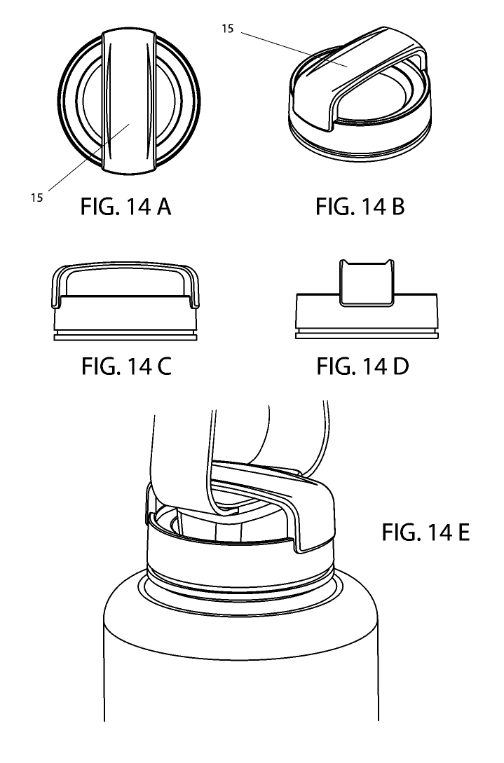

Rather that the rubber band-like strap above, the embodiment seen in FIGS. 14A-14E has a semi-rigid clip 15 that snaps on the edges of the cap portion to secure a headlamp.

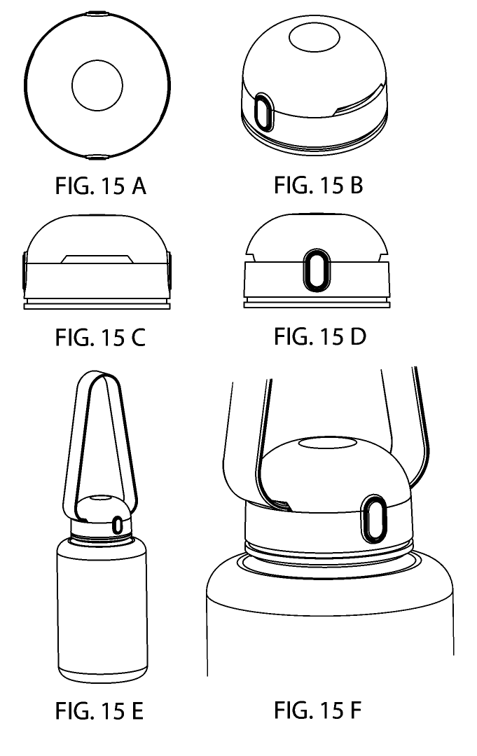

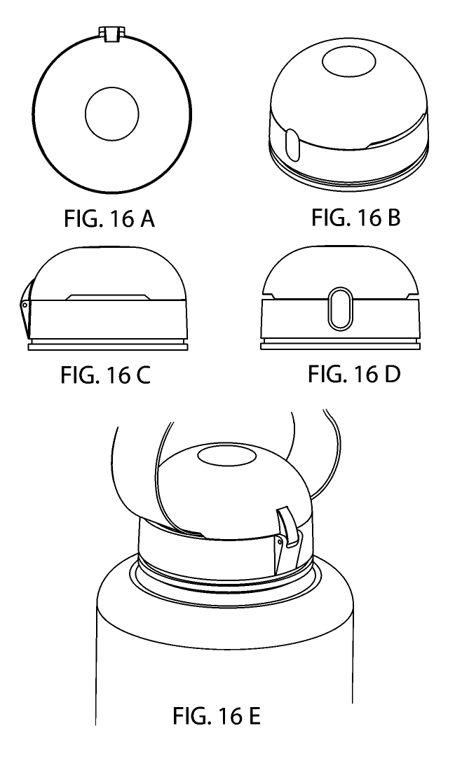

FIGS. 15A-15F and 16A-16E show an embodiment in two variations. In common, these caps have a semi-rigid domed lid. The lid fits completely over a retained headlamp and has horizontal slots to allow the straps to exit. The version in FIGS. 15A-15F is a distinct component with a snap-fit to the cap proper, while the version of FIGS. 16A-16E is hinged on one side and snap fit on the opposing side. When not is use as a lantern, the area under the dome can be a secondary storage compartment.

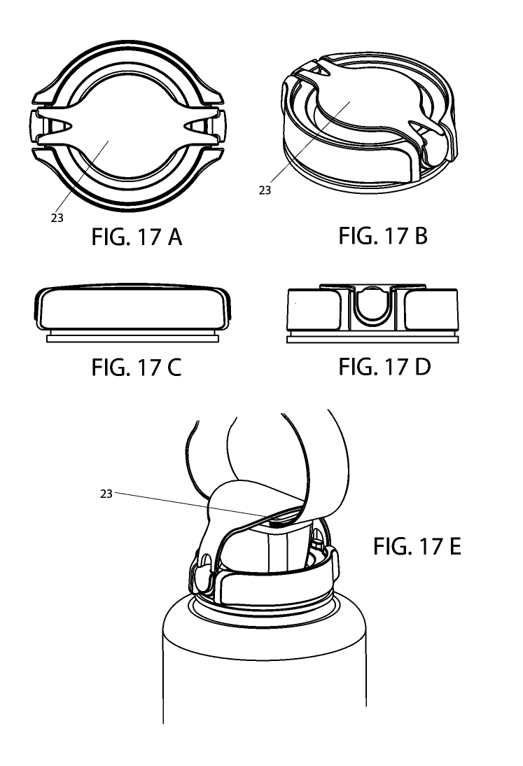

The cap shown in FIGS. 17A-17E is a variation of the version seen in FIGS. 13A-13F. In this latter case, the resilient strap 23 is wider and circular, providing greater support in retaining a headlamp to the cap.

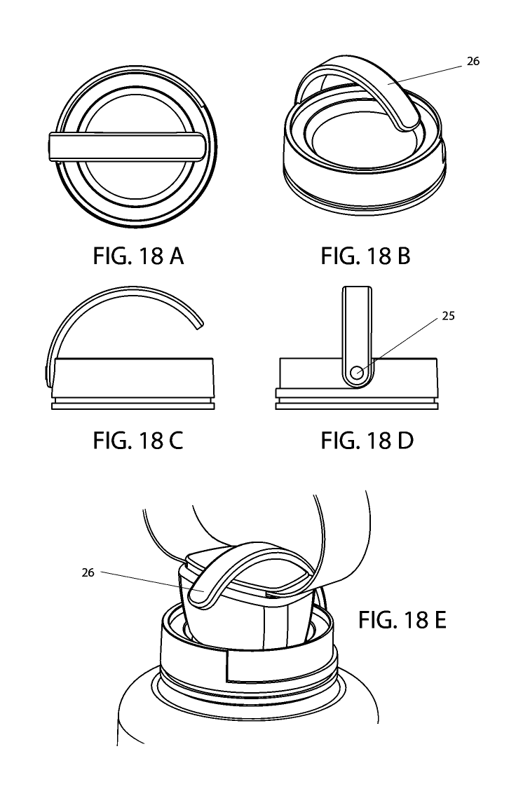

The cap shown in FIGS. 18A-18E has a semi-rigid partial bail-like handle 26 with a pivot connection 25 to the cap proper. It can be thought of as a hook in that it has one end open. This hook can be used to hang the water bottle itself or, as shown, to retain a headlamp.

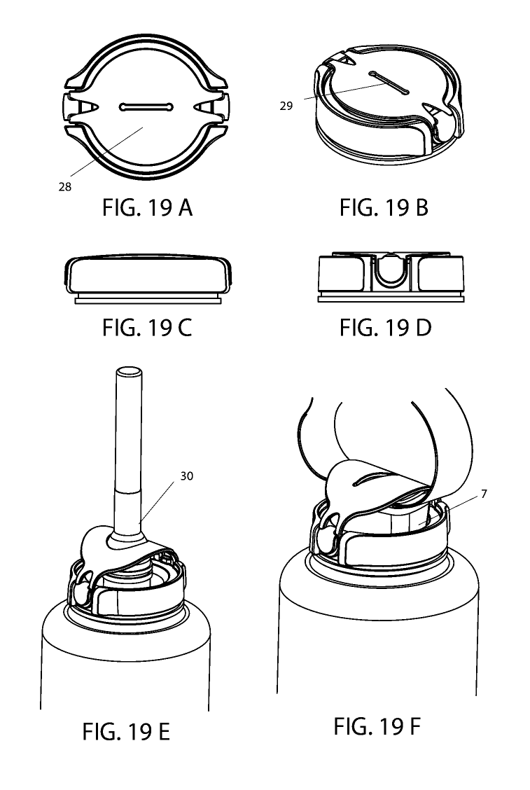

FIGS. 19A-19F show another version of the embodiment seen in FIGS. 13A-13F and in 17A-17E. This version is almost identical to that of FIG. 17A, except the strap 28 has a centrally located slot 29. As seen in FIG. 19E, this structure can alternately retain a small flashlight 30 by inserted into the slot. Of course it can also be used to secure a headlamp 7 as shown in FIG. 19F.

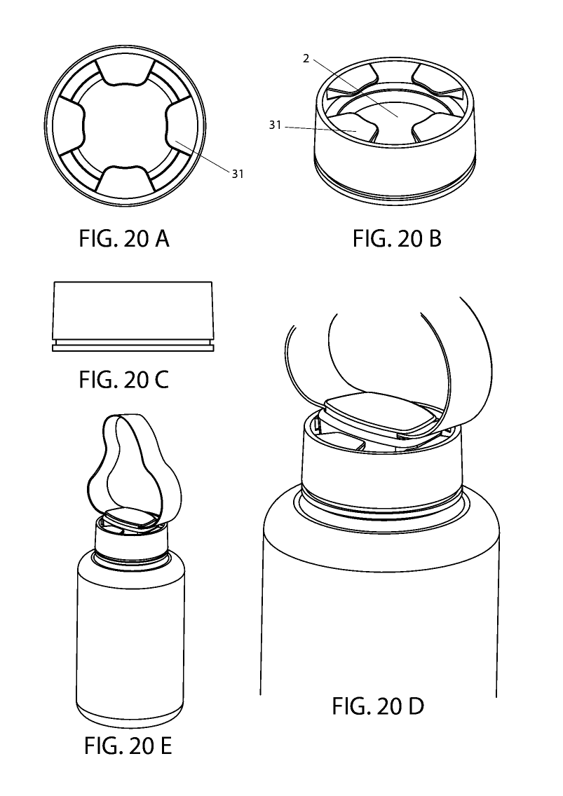

Rather than the retainer for a headlamp being a structure that extends over the headlamp, FIGS. 20A-20E retain a headlamp by elastomeric force created on the sides of the headlamp. It has four symmetrically arrayed elastomeric tabs 31 on the top of the cap that are of a length to capture a headlamp and secure it above the lens 2. This acts like many cup holders to grasp the head amp. If the lamp is held well enough, there is no need to have any structure to capture the straps.

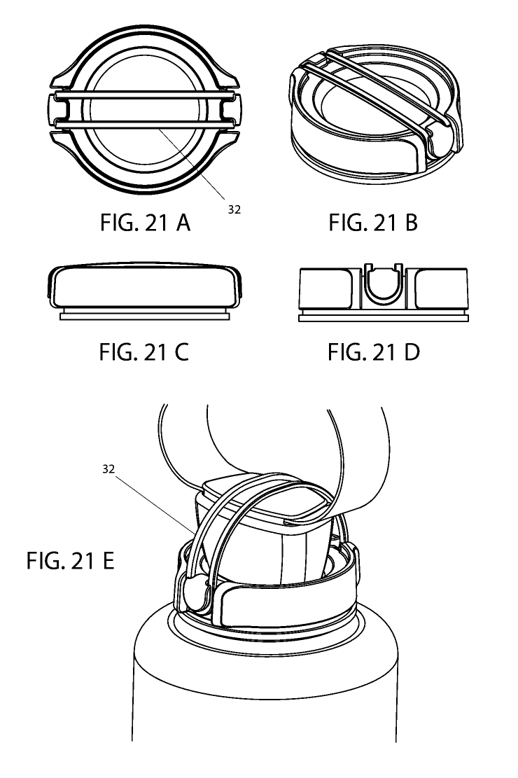

Yet a fourth variation of the embodiments of FIGS. 13A, 17A and 19A is shown in FIGS. 21A-21E. In this version the strap 32 is very much like the structure of a rubber band.

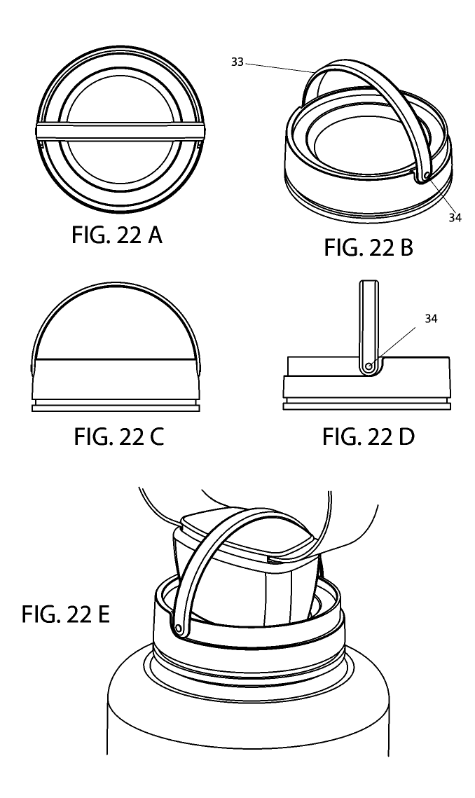

FIGS. 22A-22F show a version similar to that of FIG. 18A. This version has a bail handle 33 that folds down to rest within a recess along the side of the cap when not in use. It has pivoting connections 34 to the cap proper. The handle can readily snap off, and back on, at least one of its two pivot points to allow a headlamp to be inserted under it as seen in FIG. 22E. That same operation can also be used to open the handle so it can be used as a hook to hang the bottle up.

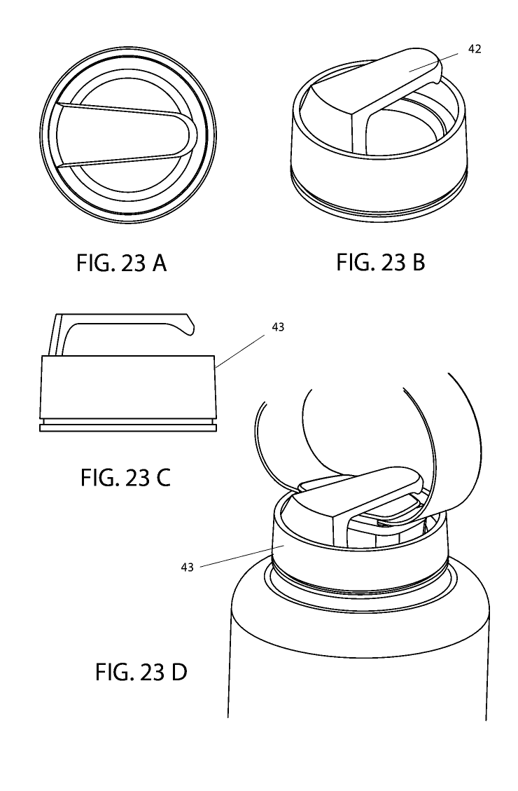

FIGS. 23A and 23B show an embodiment with a single resilient arm 42 extending from one side 43 of a cap to a position that can capture a headlamp.

These teachings may be applied to vessels other than water bottles and do have applications outside of camping. A particular application may require alternate materials and construction details.

While numerous, these embodiments and versions represent non-limiting examples. The metes and bounds of the presently claimed invention are expressed in the claims. In those claims, the word “a” is meant to be understood as “one or more” when operationally feasible even though the explicit “one or more” may appear in other places in the claims.

It is claimed:

1. A cap for a vessel, the cap having an upper, external structure adapted to temporarily, mechanically retain, facing downward, and optically interface to, an existing headlamp having straps, the optical interface comprising a light director adapted to direct light from the headlamp into a caped vessel, in use.

2. The cap of claim 1 in combination with a compatible vessel and where the vessel is a transparent or translucent water bottle.

3. The cap of claim 1 where the upper, outer surface of the cap is at least partially concave.

4. The cap of claim 3 where the light director comprises a lens.

5. The cap of claim 3 where the retaining between cap and a retained headlamp is via securement of the cap to the headlamp's straps.

6. The cap of claim 5 where the retaining structure comprises paired, opposing elastomeric fingers disposed circumferentially at respective opposite side of the cap, the opposing fingers having a gap and the gaps offset between the paired fingers on a left side and those on a right side.

7. The cap of claim 1 where the light director comprises a protrusion configured to extend substantially into the vessel, in use.

8. The cap of claim 1 where retention between the cap and a retained headlamp is via an elastomeric fitting, integral with the cap, that extends above the headlamp in use.

9. The cap of claim 1 where retention between the cap and its retained headlamp is via an elastomeric fitting, detachable from the cap, extending above the headlamp.

10. The cap of claim 1 where the retaining between the cap and a retained headlamp is via an elastomeric force substantially applied to the sides of the headlamp by structures on the upper surface of the cap.

11. The cap of claim 1 where the retaining between the cap and a retained headlamp is via a member extending over the headlamp and snap-fit to the body of the cap at least at one end.

12. The cap of claim 1 where the retainer comprises a bail.

13. The cap of claim 1 where the retainer comprises a domed lid, the lid having at least two openings to accommodate two strap portions and where closing the lid over a headlamp provides the retaining.

14. The cap of claim 1 comprising a mechanical retention that is a wide strap adapted to retain a headlamp and the strap is further adapted to alternatively retain a flashlight via an aperture in a central region of the wide strap.

15. A method of providing diffuse ambient light comprising, in any operative order:
a) attaching the cap of claim 1 to a vessel, the vessel comprising a compatible and translucent bottle;
b) temporarily securing a headlamp to the outside, upper surface of the cap; and
c) turning on the headlamp;
whereby light from the secured headlamp is directed into the bottle towards the inner sidewalls of the bottle and produces a diffuse ambient light.

16. The method of claim 15 where the securement is via retaining headlamp straps.

17. A cap for a water bottle comprising:
a threaded lower portion adapted to connect to a compatible bottle;
a transparent or translucent central portion comprising a light director configured to direct light impinging on the upper, outer surface of the cap into a connected bottle; and
means for temporarily securing a headlamp having straps, face down, to the outer surface of the cap such as to direct light to the transparent or translucent portion.

18. The cap of claim 17 where the light director comprises a lens.

19. The cap of claim 17 where the upper, outer surface of the cap is at least partially concave.

20. The cap of claim 19 where the retention between cap and a secured headlamp is via entrapment of the headlamp's straps by structures of the cap.

21. The cap of claim 20 where the securing structure comprises paired, opposing elastomeric fingers disposed circumferentially at respective opposite side of the cap, the opposing fingers having a gap and the gaps offset between the paired fingers on a left side and those on a right side.
